(19) United States
(12) Patent Application Publication
(10) Pub. No.: US 2009/0089319 A1
(43) Pub. Date: Apr. 2, 2009

(54) System and Method for Differentiating Duplicate Addresses in a Locality

(75) Inventor: Michael Geilich, Hanover, NH (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 12/212,458

(22) Filed: Sep. 17, 2008

Related U.S. Application Data
(60) Provisional application No. 60/976,734, filed on Oct. 1, 2007.

(51) Int. Cl. G06F 17/30

(52) U.S. Cl. 707/102; 707/104.1; 707/E17.018; 707/E17.045

(57) ABSTRACT

A method and system are presented for differentiating duplicate addresses within a locality. A relational database of geographical features is constructed where each geographical feature has related attributes which can be used to differentiate among multiple same-named features. Precedence hierarchies of such attributes can be created within the database where each precedence hierarchy is constructed based on a combination of user type and situational scenario information. Upon receiving a mapping destination from a user, the system may identify the input as being ambiguous. The user and situation can be analyzed in order to select the precedence hierarchy best fit to resolve the ambiguity in this particular situation. The selected hierarchy can then be traversed until an attribute is found that exists for both features and serves to distinguish between them. The attributes can be presented to the end user along with information regarding the ambiguity.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CLAIM OF PRIORITY

This application claims priority to U.S. Provisional Patent Application 60/976,734 filed Oct. 1, 2007, by Michael Geilich, entitled SYSTEM AND METHOD FOR DIFFERENTIATING DUPLICATE ADDRESSES IN A LOCALITY, which is hereby incorporated by reference.

### CROSS REFERENCE TO RELATED APPLICATIONS

The following commonly owned, co-pending United States Patent Applications are related to the present Application. Each of the other patents/applications are incorporated by reference herein in their entirety:

U.S. patent application Ser. No. 11/433,104, entitled “LOCALITY INDEXES AND METHOD FOR INDEXING LOCALITIES” by Michael Geilich, filed on May 12, 2006 (Attorney Docket No. TELA-07767US0);

U.S. patent application Ser. No. 11/345,877, entitled “METHOD FOR DIFFERENTIATING DUPLICATE OR SIMILARLY NAMED DISJOINT LOCALITIES WITHIN A STATE OR OTHER PRINCIPAL GEOGRAPHIC UNIT OF INTEREST” by Michael Geilich, filed on Feb. 1, 2006 (Attorney Docket No. TELA-07770US0).

### FIELD OF THE INVENTION

The current invention relates generally to mapping databases and mapping software applications and more particularly to resolving duplicate addresses and other ambiguous user input.

### BACKGROUND

In recent years, map databases, global positioning systems (GPS) and other navigation software and hardware have become widely used by consumers in a variety of different contexts. For example, in-vehicle navigation systems enable drivers to find their destinations by providing real-time routing instructions, while personal digital assistants (PDAs) and cellular telephones allow easy directions to any geographic location. In a similar manner, almost any device having access to the internet, from personal computers to tiny handheld devices, can be loaded with navigation applications which can generate maps showing desired locations or directions on how to get there.

One widespread feature implemented by such devices is a mapping database of geographical features as well as software used to retrieve and manipulate information in the mapping database. For example, to receive driving directions from a vehicle navigation system, a user is usually prompted to enter a desired address, at which point the software application can look up the location of the address in the mapping database, compute a path from some current location to the location of the address and provide routing or other instructions to the user. In general, a user enters an address, a name of a business, landmark or the like, and the navigation application determines the map database feature that corresponds to the user's request and uses information about that feature, such as using its location to provide driving directions.

Map-driven applications allow a user to select a geographic location in a variety of ways. Selecting a point from a graphic display of a map and entering the desired latitude/longitude coordinates are some examples. The present embodiments apply to situations where the end user specifies a geographic location by naming the location, such as with an address or an intersection of two named streets. Such specification can be made through text entry, voice, or any other method that the application may support. It also applies to all of the methodologies such applications use to accept and process user input. This includes “top down” where the user enters a locality (e.g. specifies description of an area), then address, “bottom up” where the user first enters the address, then the locality, and “all at once” where the user enters both locality and address.

One problem can occur when the user specifies a location that is ambiguous, i.e. when no unique match to the user input can be found within the database. This can happen for a multitude of different reasons. The user input may be erroneous or incomplete or the reference database can be erroneous and incomplete. Even if the input and database are perfect, the mapping application may have trouble uniquely identifying destinations, such as in the case where duplicate addresses exist for two or more different locations within a city. An example of this is illustrated in FIG. 1 where the address “2 Adams St., Boston, Mass., U.S.A.” yields multiple different and unique locations (100-110), each located in a different locality within the city of Boston. As shown therein, if a user were to request “2 Adams St., Roxbury, Mass.”, the answer would be unique. However, the address “2 Adams St., Boston, Mass.” is ambiguous. One problem with entering the more specific name first (especially in the case of a neighborhood) is that the user doesn't know that it is needed because the formal address uses the city and not the neighborhood. It should be noted that the map illustrated in FIG. 1 is shown merely for purposes of illustration and is not intended to be an accurate nor complete map representation.

Mapping software that does not detect and resolve such ambiguities can be problematic. Navigation applications in particular can lead users on wild goose chases and into undesirable places. When a user interface arbitrarily chooses a single answer among multiples, there is a chance that the user is led to a wrong destination and given no indication that there is a problem. Even if the application does offer additional information to aid the user in disambiguating the situation, that information may be cumbersome or of little value to the user. For example, some applications present the user with multiple choices using the ZIP code attribute to differentiate between duplicate street addresses. However, ZIP codes are often not useful because users tend not to know the areas defined by ZIP codes and ZIP codes cannot generally be found on roadway signs or street atlases or road maps. Other applications attempt to disambiguate but do a poor job such as by providing incorrect disambiguating information. Plotting the various choices no a map (such as in FIG. 1) may also not be very helpful, as the user may not be familiar with the location.

In light of the foregoing, a new system for differentiating between duplicate addresses is desirable, one which can provide the user with tailored and useful information to resolve most address ambiguities and one which could dynamically adapt to the particular situation at hand in order to more efficiently route the user to the desired destination. The applicant has identified these, as well as other needs, which currently exist in the art, in coming to conceive the subject matter of the present disclosure.

### BRIEF DESCRIPTION OF THE DRAWINGS

FIG. 1 is an illustration of a map showing duplicate and ambiguous addresses for several geographical locations, in accordance with various embodiments.

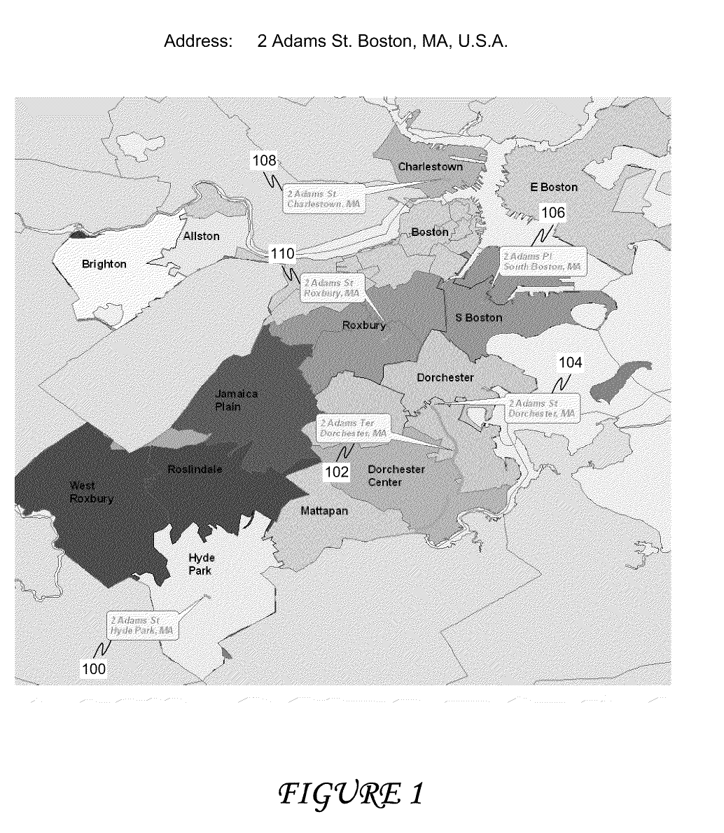

FIG. 2 is an illustration of a system that can be used to differentiate between duplicate addresses in a locality, in accordance with various embodiments.

FIG. 3 is an illustration of construction of a relational feature database, in accordance with various embodiments.

FIG. 4 is an illustration of a matrix of standard and custom user attribute hierarchies, in accordance with various embodiments.

FIG. 5 is an illustration of disambiguation using feature attributes, in accordance with various embodiments.

FIG. 6 is an illustration of a general overview process flow chart, in accordance with various embodiments.

FIG. 7 is an illustration of a logical process flow chart, in accordance with various embodiments.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in an accessible device or appliance with storage capacity. Furthermore, it can also be apparent to those skilled in the art that such components, regardless of how they are combined or divided, can execute on the same computing device or can be distributed among different computing devices connected by one or more networks or other suitable communication means.

The embodiments of the present invention can provide systems and methods for differentiating between duplicate addresses in a locality for use with electronic maps and electronic map databases. A methodology is enabled for adding meaningful and distinguishing features to the duplicate addresses in order to provide the end user with the best information for selecting a desired unique location. Mapping software applications can be improved by consistently choosing disambiguating information that is most useful to a particular end user in a particular situation. For example, for navigation software, the disambiguating information includes information that can be found on roadway signs or in a road atlas, or may be more generally known to the user when driving.

In various embodiments, the method for differentiating duplicate addresses generally begins with constructing a relational database of geographical features and their related attributes. Geographical features can include but are not limited to addresses, landmarks, businesses and other particular geographical locations. In one embodiment, each geographical feature can be uniquely represented by a pair (or multiple pairs) of longitude (LON) and latitude (LAT) coordinate attributes. Attributes represent supplemental information associated with each geographical feature, such as town or neighborhood names, postal codes, intersections, phone numbers, landmarks, business and resident names, pictures, videos and the like. For example, a particular address usually has a ZIP code attribute and a city name attribute associated therewith. The methodologies for constructing a relational database are well known in the art. Techniques used to relate all of the desired geographic features with their appropriate attributes include but are not limited to geocoding, address matching, postal standardization and conflation.

Once such a relational database is constructed, many different attributes can be used to disambiguate same-named geographic features. For example, the precise LAT/LON coordinates of the duplicate features may be most accurate, but are often of limited direct utility because people do not generally know them. On the other hand, in certain situations, geographic coordinates can be an extremely useful differentiator. For example, in a mapping application, using coordinates to generate map displays of the choices may be useful to users who know the general area around the feature they are searching for. In the majority of cases, however, raw coordinates will not be useful to most end users.

Depending on the particular situation and the particular end user, other attributes can be better choices for disambiguation. In some embodiments, postal codes (ZIP codes) can be used to disambiguate some duplicate street addresses. This attribute may be useful for the end user that knows the areas represented by postal codes, such as a mail/delivery person. The name of a small town or a neighborhood within a large city is another attribute which may be useful to residents of the city. Another attribute can be intersecting streets, which may be useful to a driver traveling on those streets and able to view the street signs. Yet another attribute can be nearby landmarks. Other examples include the name(s) of the business or residents at the addresses and pictures or videos of the locations. Each of these related attributes has value to certain users in certain situations. It is noted, however that the attributes are listed for illustrative purposes and are not intended to be an exhaustive list.

In various embodiments, the method for differentiating between duplicate addresses involves creating precedence hierarchies of the attributes useful (or possibly useful) to differentiate between same or similarly named geographic features. A precedence hierarchy can be constructed based on a user and situation scenario. Thus, in one embodiment, each unique user/scenario combination will have its own hierarchy of preferred attributes used for disambiguation. For example, if the end user is a driver, traveling at daytime, in an automobile, and is a local (non-visitor), a precedence hierarchy of attributes may be structured in the following prioritized order:

1. Towns/Neighborhoods

2. Landmarks

3. Intersections

4. Phone numbers

5. Postal Codes

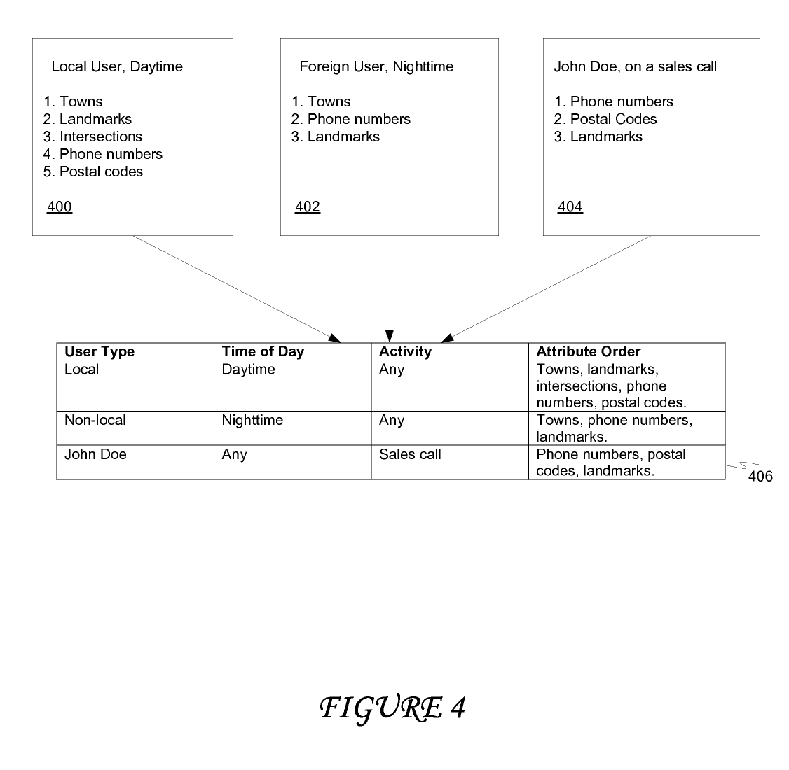

As illustrated above, the precedence hierarchy lists the most preferred attribute first and ends with the least preferred attribute for differentiating between duplicate addresses for the given situation. Thus, a town or neighborhood name within a large city is likely most useful to a local resident since they are likely to be more familiar with such information than an out-of-town visitor. The factors affecting the choice of attributes will be described in more detail in conjunction with FIG. 4 discussed below. It should also be noted that this hierarchy is provided only for purposes of illustration and that any arbitrary hierarchy can be created and associated with the user/scenario combination.

In one embodiment, the hierarchies are constructed through algorithmic analysis of the user type and situation. For example, if the local time is 11 pm, the application can identify the situation as being nighttime. If the on/off time of the navigation device indicates that the end user has been on the road continually for the last week, an assumption can be made that the user is a non-local traveler. If the navigation device takes many small trips over the same specified geographic range for a long period of time, the algorithmic analysis can deduce that the end user is a local resident. The urban or rural characteristics of the geographic area can be identified by analyzing the density of the roads, population or other means. In constructing the hierarchies, the address attributes can be generally preferred over non-address attributes. Address attributes include house numbers, street directionals and types, and secondary information such as buildings and suites. These attributes are preferred since they are generally known to most users in most types of situations. In addition to algorithmically deducing the situation and user type, the user can also be queried as to which attributes they would prefer to use for disambiguation.

In one embodiment, once the precedence hierarchy is generated, it can be stored in the relational database for later use by mapping software applications. In alternative embodiments, the precedence hierarchy can be generated dynamically on-the-fly at the time of identifying the ambiguity. In one embodiment, each entry in a precedence hierarchy is a single attribute. In alternative embodiments, hierarchy entries may be combinations of attributes.

In various embodiments, a typical mapping application (such as part of a vehicle navigation system) receives input from a user which specifies a geographical location. In one embodiment, the user may enter an address via a graphical user interface (GUI) of an electronic device. In alternative embodiments, the user may enter information by speaking, or by other means. The mapping application can analyze the input and identify it as being ambiguous, i.e. as not matching a unique feature in the database. In that case, the mapping application can perform the algorithmic analysis of the user and the various situational context factors in order to determine the user type and situational scenario, as previously described. Based on this analysis, a precedence hierarchy can be selected. Once a hierarchy is identified, the attributes can be traversed from most preferred to least-preferred until an attribute is found that can resolve the ambiguity for the particular situation at hand. In one embodiment, the attributes from the precedence hierarchy are traversed by presenting the attributes to the user in sequence, starting with a most-preferred related attribute in the hierarchy and going down to a least-preferred related attribute until an attribute is found that exists for the two (or more) geographic features and distinguishes between those two geographic features. In this manner, the distinguishing is not successful unless the user can recognize the distinction and can use it to disambiguate the situation for him/her. In some embodiments, the attributes are presented to the user one at a time, while in alternative embodiments, multiple attributes can be displayed at once.

In some cases, a certain attribute may not be sufficient to resolve the uncertainty. For example, if the preferred attribute is town name, but the ambiguity exists within a single town, then the town name cannot be used to resolve it and a lesser preferred attribute should be used. Similarly, if the preferred attribute is a phone number, but phone numbers for these particular features are not known (not part of the relational database), then phone numbers cannot be used. In one embodiment, the hierarchy is traversed until an attribute is found that (1) exists for the duplicate features and (2) serves to distinguish the features. That attribute, along with the identification of the ambiguity can be presented to the end user for choice. In one embodiment, information is presented to the user as text output on a graphical user interface (GUI). In alternative embodiments, information is converted to sound to be presented to the user as speech or by other means. If no suitable attribute can be found in the preferred hierarchy, other hierarchies can be searched for other attributes to use, even though they may not be optimal for the particular user and situation. In alternative embodiments, multiple attributes may be used simultaneously to present disambiguating information to the user and attributes may be selected without regard to the user profile or precedence hierarchy. If no suitable attribute can be found for disambiguation, it may still be important for the application to identify an ambiguous situation, even if it cannot be resolved.

It should be noted that the precedence hierarchies feature should not be construed as a limitation to all of the embodiments of the present disclosure. For example, in certain embodiments, no hierarchical structure nor priority ordering is used. Rather, a cluster of related attributes can be generated based on the user and/or scenario. The cluster can be a collection of these attributes without regard to any particular order, and in one embodiment, a user can be presented with all of the attributes in a cluster when disambiguating input. While this technique may not be as efficient as prioritized hierarchies in certain circumstances, it can be implemented nonetheless.

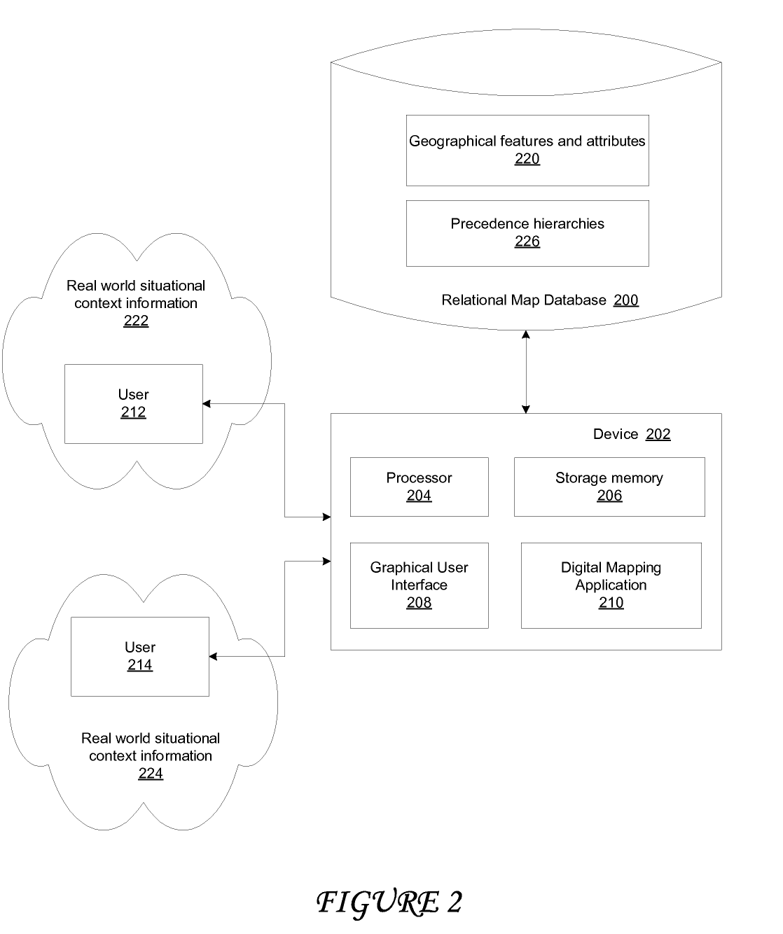

FIG. 2 is an illustration of a system that can be used to differentiate between duplicate addresses in a locality, in accordance with various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

As illustrated, a hardware navigation or other physical device 202 can include a processor 204, storage memory 206, a graphical user interface (GUI) 208, as well as a digital mapping software application 210 for providing routing instructions. The physical device 202 can take the form of an in-vehicle GPS navigation system, a personal computer, a laptop, a cellular telephone, a personal digital assistant (PDA) or the like. In one embodiment, multiple users 212, 214 can use the physical device 202 in order to obtain digital maps, routing instructions and other information generally provided by mapping applications 210.

In various embodiments, the mapping information can be stored in a relational map database 200 which is available for access by the device 202. In one embodiment, the relational database 200 can be physically integrated into the physical device 202, while in alternative embodiments, the database can be remotely accessible by the device, such as via a network (e.g. internet) or other means. The relational database can store all of the desired geographical features 220 and supplemental attributes related to these features. In one embodiment, some or all of these attributes can be used to distinguish between same-name geographical features (e.g. duplicate addresses). In addition, the relational map database 200 can store a set of precedence hierarchies 226 that organize the attributes in a prioritized order from the most-preferred for distinguishing between duplicate addresses to the least-preferred. The precedence hierarchies can be constructed based on the information about the users 212, 214 and also based on real world situational context information 222, 224. Examples of real world situational context information include information about the time of day (e.g. daytime/nighttime), information about duration of travel, information about means of travel (e.g. in-car navigation), information about the general geographical area (e.g. urban/rural), weather information (e.g. foggy/clear/raining), traffic information and the like. It should be noted that these examples are provided purely for purposes of illustration and are not intended to be in any way limiting or exhaustive.

In one embodiment, upon receiving ambiguous input from a user 212, 214, the digital mapping application can evaluate the situational context information 222, 224 and select an appropriate precedence hierarchy to use for disambiguation. In one embodiment the precedence hierarchy can be retrieved from the database 200. Alternatively, the hierarchy can be dynamically generated by the mapping application 210 upon receiving the input from the user. In either case, the precedence hierarchy is traversed until a suitable attribute is found that serves to resolve the ambiguity. In this manner, a more accurate and precise mapping and navigation system can be provided to the end user.

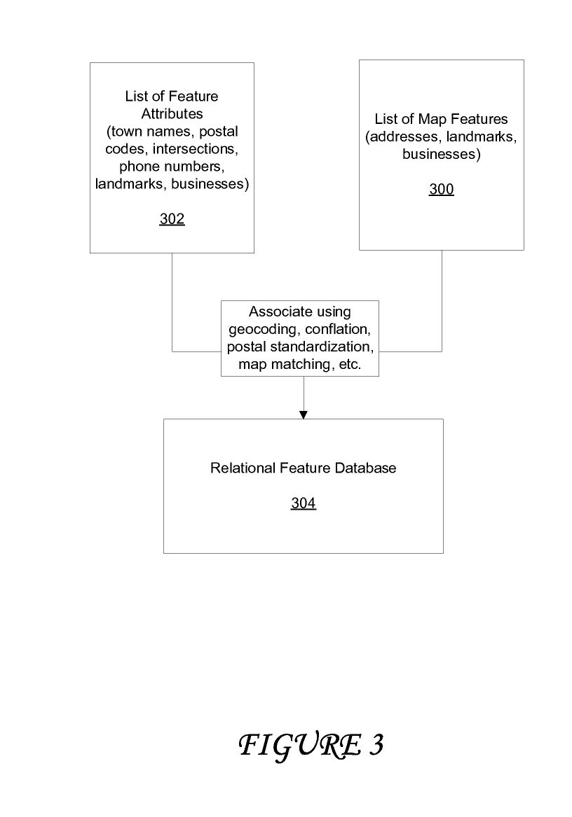

FIG. 3 is an illustration of construction of a relational feature database, in accordance with various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

As illustrated, the relational feature database 304 can be constructed by taking a list of geographical map features 300 such as addresses, landmarks and businesses and associating them with supplemental feature attributes 302 such as town names, postal codes, intersections, phone numbers, landmarks, businesses and the like. The association can be performed using geocoding, conflation, postal standardization, map matching and other similar techniques. For example, geocoding is a well-known technique for assigning location identifiers, such as latitude and longitude coordinates, to the geographic map features.

Once such a relational feature database is constructed, certain attributes can be used to differentiate between features having the same name or other ambiguity. For example, the postal code attribute can often be used to differentiate between two different locations having duplicate addresses.

FIG. 4 is an illustration of a matrix of standard and custom user attribute hierarchies, in accordance with various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

Illustrated in FIG. 4 are several precedence hierarchies of attributes where each hierarchy is configured for a different user and scenario combination. For example, if the user is a local resident and the ambiguity occurs during daytime, the hierarchy of attributes 400 includes towns, landmarks, intersections, phone numbers and postal codes. Therefore, if user input matches several duplicate addresses and the user/scenario information is matched to this hierarchy, the mapping application will first attempt to use town names to differentiate between the duplicate addresses. If the town names are not known or cannot be used to distinguish between the features, nearby landmarks will next be attempted. If landmarks cannot be used, intersections will be attempted and so forth.

Other examples of such hierarchies are shown in elements 402 and 404. For example, if the user is a foreign user and the activity occurs during nighttime, the hierarchy 402 includes towns, phone numbers and landmarks. If none of these are usable to resolve the ambiguity, other hierarchies can also be attempted such as hierarchy 400, discussed above. Hierarchy 404 illustrates an example of a custom precedence hierarchy that includes a specific user engaged in a specific activity, such as employee John Doe on a sales call. This situational scenario can be created by querying the user John Doe for which attributes are preferred to disambiguate input, or alternatively the attributes can be selected automatically.

In various embodiments, all of the precedence hierarchies can be stored in a table(s) 406 in the electronic map database, which is accessible by various mapping applications. Alternatively, the hierarchies can be stored elsewhere (e.g. disk, file storage), or can be dynamically generated upon identifying the ambiguity.

The particular selection of attributes in the hierarchy can be performed by the mapping software based on a multitude of different factors. For example, using latitude/longitude coordinates to center map displays may be useful to a local user who knows the surrounding geographic area. Such displays for the foreign user may offer little help. A postal worker or other delivery person may be comfortable using postal codes for disambiguation. An end user who has the phone number of their intended destination may be comfortable using phone numbers for disambiguation. A user driving a vehicle may be comfortable using visible landmarks or intersecting streets for disambiguation. Similarly, in general user vehicle navigation, postal codes tend not be a very useful disambiguator because their locations and extents are not generally well known, nor are they displayed on street signs. Furthermore, users driving in cars at night may not be comfortable using intersecting streets as differentiators if it s difficult to see the signs. All of these, as well as other additional factors should be considered when generating the precedence hierarchies 400, 402, 404 for the particular user/scenario combinations.

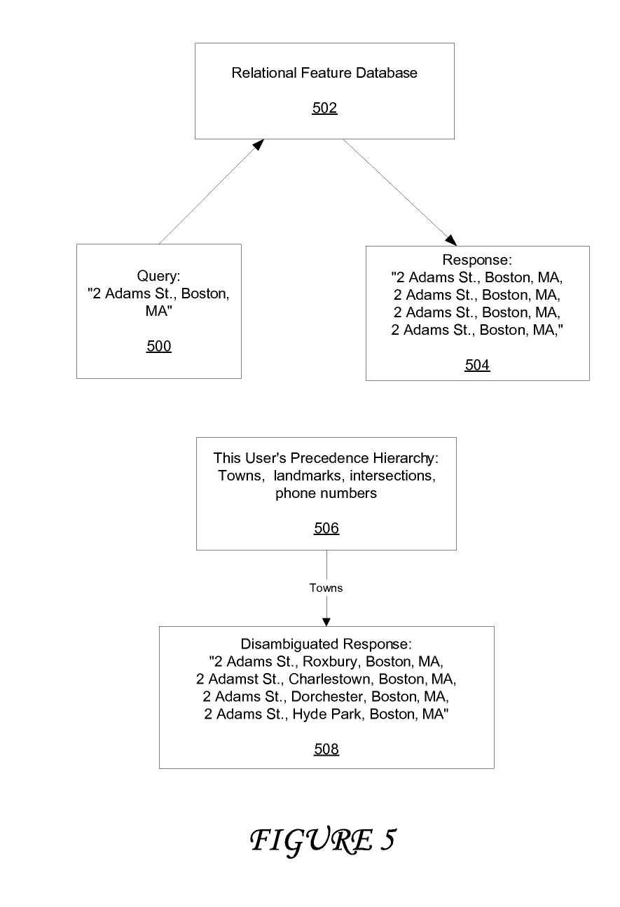

FIG. 5 is an illustration of disambiguation using feature attributes, in accordance with various embodiments. Although this figure depicts functional steps in a particular sequence for purposes of illustration, the process is not necessarily limited to this particular order or steps. One skilled in the art will appreciate that the various steps portrayed in this figure can be changed, rearranged, performed in parallel or adapted in various ways. Furthermore, it is to be understood that certain steps or sequences of steps can be added to or omitted from this process, without departing from the spirit and scope of the invention.

As shown in step 500, a query can be received by the mapping application specifying a geographical location. For example, a query can specify the address “2 Adams Street, Boston, Mass.” During resolution of the query, the application can retrieve all records (features) from the relational database 502 which match the specified address. In one embodiment, if only one unique record is retrieved, then no ambiguity exists. If, on the other hand, multiple geographical features 504 match the query, the system can identify the query as being ambiguous and attempt to resolve the ambiguity as described below.

In one embodiment, the mapping application can retrieve the end user's precedence hierarchy based on information about the user and based on context information about the situation that the user is involved in. In this particular illustration, the user's precedence hierarchy 506 lists towns as the most preferred attribute to resolve ambiguities. The application can determine whether the town names would be sufficient to differentiate between the geographical features in the database. If this attribute is sufficient, application can provide a disambiguated response 508, allowing the user to select a unique feature from the list based on the attribute. If the attribute would not be sufficient, the next attribute in the hierarchy can be attempted (i.e. landmarks). Once a distinguishing attribute is found, the user can be presented with that attribute and the identification of the ambiguity for resolution of the ambiguity.

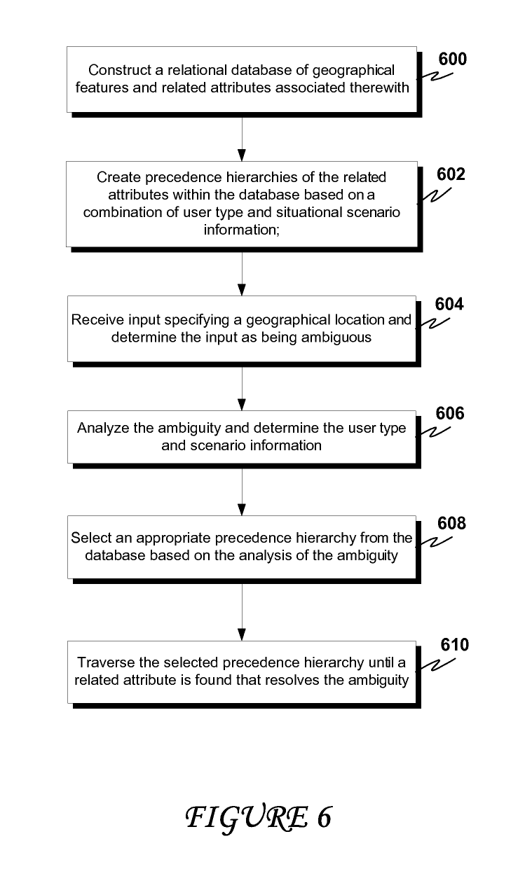

FIG. 6 is a general flow chart diagram of the method for differentiating between duplicate addresses in a locality, in accordance with various embodiments. Although this figure depicts functional steps in a particular sequence for purposes of illustration, the process is not necessarily limited to this particular order or steps. One skilled in the art will appreciate that the various steps portrayed in this figure can be changed, rearranged, performed in parallel or adapted in various ways. Furthermore, it is to be understood that certain steps or sequences of steps can be added to or omitted from this process, without departing from the spirit and scope of the invention.

As illustrated in step 600, the process can begin with constructing a relational database of geographical features and their related attributes. Once the database is created, a precedence hierarchy can be generated for each user and situation, as shown in step 602. The hierarchies can be created algorithmically by the electronic map system or by querying the user for preferred attributes to use in disambiguation.

In step 604, input is received from the user, indicating a geographical location. This input is determined to be ambiguous when the input cannot be matched to a single unique geographic feature in the constructed database. In step 606, the ambiguity is analyzed and the mapping application determines the user type and scenario information. For example, the mapping application may determine that the user a foreign non-resident traveling in an automobile at nighttime. In step 608, an appropriate precedence hierarchy is selected from the database based on this analysis. Once the hierarchy is selected, it can be traversed by attempting to use each attribute to resolve the ambiguity in their prioritized order, as shown in step 610.

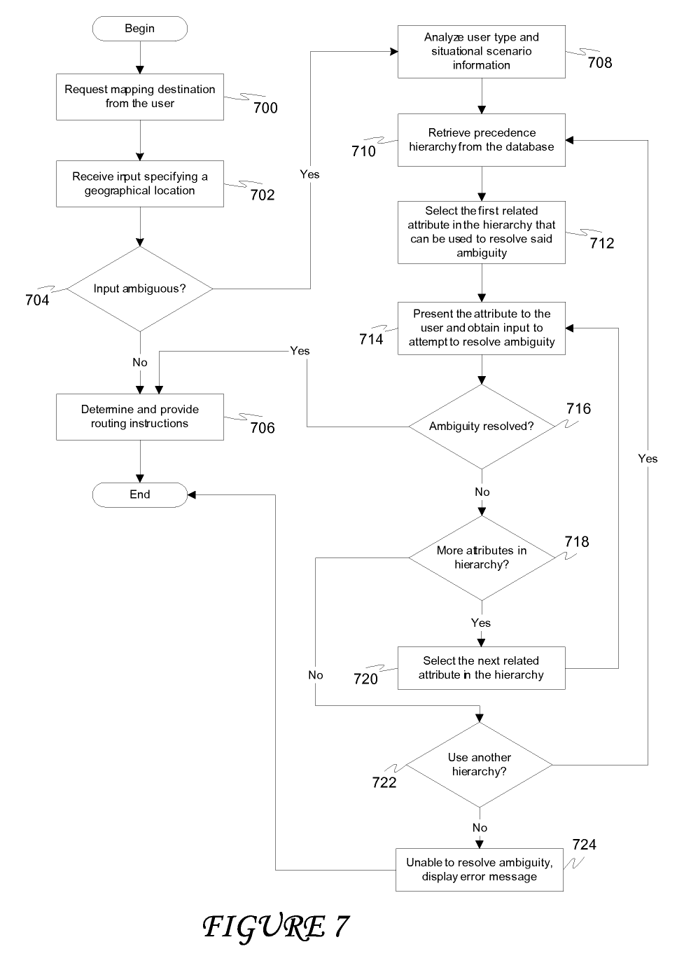

FIG. 7 is an illustration of a logical process flow chart of a mapping application, in accordance with various embodiments. Although this figure depicts functional steps in a particular sequence for purposes of illustration, the process is not necessarily limited to this particular order or steps. One skilled in the art will appreciate that the various steps portrayed in this figure can be changed, rearranged, performed in parallel or adapted in various ways. Furthermore, it is to be understood that certain steps or sequences of steps can be added to or omitted from this process, without departing from the spirit and scope of the invention.

The process illustrated in FIG. 7 assumes that an appropriate relational database has already been constructed. As shown, the process begins in step 700, where the navigation system can request a mapping destination from the end user. In step 702, the user enters a query or otherwise specifies a desired geographical location. In step 704, it is determined whether the user's input is ambiguous. In one embodiment, the input is ambiguous if it yields more than one unique geographical feature from the database. If no ambiguity exists, the navigation application can calculate the routing instructions and present them to the end user, as shown in step 706.

If an ambiguity is found, the user type and situational context information is algorithmically analyzed in step 708. Based on this analysis, a precedence hierarchy is retrieved from the database in step 710. Alternatively, the precedence hierarchy can be created at this point in the process. In step 712, the first highest priority attribute is selected from the hierarchy, which can be used to differentiate between the duplicate addresses causing the ambiguity. In step 714, this first highest priority attribute is presented to the end user. At this point the user can provide input and in step 716, it is determined whether the ambiguity has been resolved. If it has been resolved, the process can continue to step 706, where the user can be provided with the routing instructions to the desired (and now unambiguous) location.

If the ambiguity is not resolved (e.g. user did not know the attribute information), in step 718 it can be determined whether there are any more attributes in the hierarchy that can differentiate between duplicate addresses. If there is another such attribute, in step 720 that attribute is selected and presented to the user for disambiguation in step 714. If there are no other attributes within the hierarchy that could be used, in step 722 the mapping application can determine whether to attempt to use a different hierarchy with other attributes. The choice of other hierarchies can be made based on similarity of user profiles, situational scenario context or other criteria. While the other attributes of a different hierarchy may not be as efficient or as readily known by this particular user, it may be advantageous to attempt to examine this option prior to displaying an error message in step 724. If another hierarchy can be used, the process selects the new hierarchy in step 710 and performs the steps 710-720 in an effort to resolve the ambiguity. If no other hierarchies exist or should be used, the mapping application can identify the ambiguity as unable to be resolved in step 724 at which point the process can terminate.

Various embodiments described above include a computer program product which is a storage medium (media) having instructions stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, micro drives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information.

Various embodiments include a computer program product that can be transmitted in whole or in parts and over one or more public and/or private networks wherein the transmission includes instructions which can be used by one or more processors to perform any of the features presented herein. In various embodiments, the transmission may include a plurality of separate transmissions.

Stored one or more of the computer readable medium (media), the present disclosure includes software for controlling both the hardware of general purpose/specialized computer(s) and/or processor(s), and for enabling the computer(s) and/or processor(s) to interact with a human user or other mechanism utilizing the results of the present invention. Such software may include, but is not limited to, device drivers, operating systems, execution environments/containers, user interfaces and applications.

The foregoing description of the preferred embodiments of the present invention has been provided for purposes of illustration and description. It is not intended to be exhaustive or to limit the invention to the precise forms disclosed. Many modifications and variations can be apparent to the practitioner skilled in the art. Embodiments were chosen and described in order to best explain the principles of the invention and its practical application, thereby enabling others skilled in the relevant art to understand the invention. It is intended that the scope of the invention be defined by the following claims and their equivalents.

What is claimed is:

1. A method for differentiating duplicate addresses within a locality, said method comprising:
constructing a relational database of geographical features, each geographical feature having one or more related attributes associated therewith wherein said related attributes are used for disambiguating between two or more geographical features; and
generating one or more precedence hierarchies of said related attributes wherein each precedence hierarchy is based on at least one of: user type and situational scenario.

2. The method of claim 1, further comprising:
receiving input from a user specifying a geographical location and identifying said input as being ambiguous with respect to a unique geographic location.

3. The method of claim 2, further comprising:
analyzing said user and one or more situational factors associated with said input in order to determine at least one of: the user type and situational scenario;
selecting a precedence hierarchy based on the determined at least one of: user type and situational scenario; and
traversing the selected precedence hierarchy until a related attribute is found to resolve said ambiguity.

4. The method of claim 3 wherein an ambiguity is caused by the input specifying two or more geographical features with duplicate addresses in said database.

5. The method of claim 4 wherein traversing the selected precedence hierarchy until a related attribute is found to resolve said ambiguity further includes:
employing the related attribute to distinguish one of said geographical features with the duplicate addresses from another.

6. The method of claim 4 wherein traversing the precedence hierarchy further includes:
traversing the precedence hierarchy starting with a most-preferred related attribute in said precedence hierarchy and going down to a least-preferred related attribute until a related attribute is found that exists for said two or more geographic features and distinguishes to the user between said two or more geographic features.

7. The method of claim 4 wherein traversing the selected precedence hierarchy further includes:
presenting the related disambiguating attributes of said precedence hierarchy to said user in a prioritized order along with said ambiguity.

8. The method of claim 3, further comprising:
selecting a different precedence hierarchy if no related attribute is found to resolve said ambiguity and traversing said different precedence hierarchy.

9. The method of claim 1 wherein generating the one or more precedence hierarchies of the related attributes within the database further includes:
querying the user for preferred attributes to use in order to resolve an ambiguity.

10. A relational database stored in a computer readable storage medium for differentiating duplicate addresses within a locality, said relational database comprising:
one or more geographical features, each said geographical feature having one or more related attributes associated therewith; and
at least one precedence hierarchy that organizes a plurality of related attributes in prioritized order based on a combination of user type and situational scenario.

11. The relational database of claim 10 wherein said plurality of related attributes are traversed in order to determine an optimal related attribute to employ for differentiating between two or more geographical features having duplicate addresses.

12. The relational database of claim 11 wherein traversing the precedence hierarchy further includes:
traversing the precedence hierarchy starting with a most-preferred related attribute in said precedence hierarchy and going down to a least-preferred related attribute until a related attribute is found that exists for said two or more geographic features and distinguishes to the user between said two or more geographic features.

13. The relational database of claim 11 wherein traversing the selected precedence hierarchy further includes:
presenting the related attributes of said precedence hierarchy to said user in a prioritized order along with said two or more geographical features having duplicate addresses.

14. The relational database of claim 11 wherein a different precedence hierarchy is selected if no related attribute is found to distinguish between said geographical features having duplicate addresses.

15. The relational database of claim 11 wherein the one or more precedence hierarchies are generated by performing an algorithmic analysis of at least one of: the user type and the situational scenario.

16. The relational database of claim 11 wherein the one or more precedence hierarchies are generated by querying the user for preferred attributes to use in order to resolve an ambiguity.

17. A system for differentiating duplicate addresses within a locality, said system comprising:
a relational database of geographical features, each geographical feature having one or more related attributes associated therewith, said relational database further including at least one precedence hierarchy of the related attributes based on a at least one of: user type and situational scenario; and
an application that receives user input specifying a geographical location, identifies said input as being ambiguous, selects the precedence hierarchy based on analyzing the user type of said user and the situational scenario associated with said input and employs at least one related attributes in said precedence hierarchy in order to disambiguate said input.

18. The system of claim 17 wherein said input is identified as being ambiguous because said input results in two or more geographical features with duplicate addresses in said database.

19. The system of claim 18 wherein the precedence hierarchy is traversed starting with a most-preferred related attribute in said precedence hierarchy and going down to a least-preferred related attribute until a related attribute is found that exists for said two or more geographic features and distinguishes between said two or more geographic features.

20. The system of claim 17 wherein the related attributes of said precedence hierarchy are presented to the user in a prioritized order.

21. The system of claim 17 wherein a different precedence hierarchy is selected if no related attribute is found to disambiguate said input and wherein at least one related attribute in said different precedence hierarchy can be used to disambiguate said input.

22. The system of claim 17 wherein the precedence hierarchy of the related attributes is generated by querying the user for preferred attributes to use in order to resolve said ambiguity.

23. A computer readable medium carrying one or more sequences of instructions for differentiating duplicate addresses within a locality, which instructions when executed by one or more processors cause the one or more processors to carry out the steps of:
constructing a relational database of geographical features, each geographical feature having one or more related attributes associated therewith wherein said related attributes are used for disambiguating between each geographical feature; and
generating one or more precedence hierarchies of said related attributes wherein each precedence hierarchy is based on at least one of: user type and situational scenario.

24. A method for differentiating duplicate addresses within a locality, said method comprising:
constructing a relational database of geographical features, each geographical feature having one or more related attributes associated therewith wherein said related attributes are used for disambiguating between two or more geographical features; and
generating one or more clusters of said related attributes based on at least one of: a user type and situational scenario.

25. The method of claim 24 wherein the related attributes in each of said one or more clusters are presented to a user to be employed for disambiguating between two or more geographical features that are ambiguously specified by user input.
